(19) United States
(12) Patent Application Publication
(10) Pub. No.: US 2013/0254033 A1
(43) Pub. Date: Sep. 26, 2013

(54) SYSTEM AND METHOD FOR DYNAMIC MEMBER SEGMENTATION AND TARGETING

(71) Applicants: Venkatesh Krishnamoorthy, Chennai (IN); Padmashwini Raghunathan, Chennai (IN); Rashmi Rupireddy, Chennai (IN); Govindarajan Krishnan, Chennai (IN)

(72) Inventors: Venkatesh Krishnamoorthy, Chennai (IN); Padmashwini Raghunathan, Chennai (IN); Rashmi Rupireddy, Chennai (IN); Govindarajan Krishnan, Chennai (IN)

(73) Assignee: Tata Consultancy Services Limited, Mumbai (IN)

(21) Appl. No.: 13/534,756

(22) Filed: Jun. 27, 2012

(30) Foreign Application Priority Data
Mar. 21, 2012 (IN) 836/MUM/2012

(51) Int. Cl. G06Q 30/02

(52) U.S. Cl. 705/14.56; 705/14.66

(57) ABSTRACT

A system and method for dynamic segmentation of members and further rewarding or transmitting one or more promotional notifications to members having an associated member profile, wherein the member profile includes one or more updatable attributes, the method comprising the steps of retrieving a segmentation rule from a promotion rule stored in a database based on triggering of a promotion or notification; dynamically assessing the qualification of members based on matching corresponding predetermined value of one or more attributes of the segmentation rule with the value of the updatable attribute of the member profile based on a rule criteria of the segmentation rule; rewarding or notifying based on a promotion or notification rule.

This application claims benefit of Serial No. 836/MUM/2012, filed 26 Mar. 2012 in India and which application is incorporated herein by reference. To the extent appropriate, a claim of priority is made to the above disclosed application.

### FIELD OF THE INVENTION

The present invention relates to marketing, retailing, and loyalty/reward programs management. Particularly, it relates to generation, distribution, and/or redemption of promotions such promotional offers and reward points.

### BACKGROUND OF THE INVENTION

Loyalty programs are undoubtedly the best means to identify and target individual customers in retail industry. Specifically, providing a customer or member with a reward, discount, or loyalty points etc. are a few methods for appreciating regular customers and also to target potential customers. Moreover, the consumers around the world are better informed about the choices available and the barriers for a customer to exit a retailer's network are the lowest they have ever been. Further, due to rising competition between retailers there has been a growing need for segmenting the loyalty members in a right way in order to effectively target customers and to encourage customers to be connected to a particular retailer.

Various loyalty programs are structured for marketing by retailers for rewarding, and therefore encouraging loyal buying behavior. However, there are inherent challenges in reaping the complete benefits of customer loyalty programs. Further, to enable better means of targeting, a retailer should be able to segment the loyalty members using the most recent details of the member. Moreover, it is necessary to identify a right segment of members for various needs like loyalty promotions, offers, campaigns and so on. But there are no easier or quicker or efficient means for marketing users to dynamically target customers or members based on the known factors of members.

In order to solve the problems existing with the present loyalty programs the current invention proposes a system and method for creating loyalty member segments in a much quicker and efficient way by just selecting the known attributes that characterizes a member and the member's purchase behavior and forming a segmentation rule and in turn using the rule dynamically for targeting.

Other features and advantages of the present invention will be explained in the following description of the invention having reference to the appended drawings.

### OBJECTIVES OF THE INVENTION

It is a primary object of the invention to provide an easy to build and efficient means for dynamically segmenting loyalty members based on a plurality of known attributes of members and targeting the members.

Another objective of the present invention is to provide means for defining a segmentation rule by selecting one or more known attributes that characterize a member and the member's purchase behavior and in turn using such a segmentation rule for dynamically targeting the members or customers.

Yet another objective of the present invention is to provide a system and method for dynamically identifying and targeting members of a loyalty program based on a member satisfying a rule criteria of a segmentation rule at any given point in time.

### SUMMARY OF THE INVENTION

Embodiments of the present invention are directed to a system and method for dynamic segmentation of members and further rewarding or transmitting one or more promotional notifications to members having an associated member profile. In an aspect, the members may be regular customers of a retailer or may be customers enrolled in a loyalty program. Further, the member profile may include one or more updatable attributes that may belong to an attribute category including but not limited to customer demographic, member loyalty, member transaction activities, member preferences, Member Loyalty Event, events related to member, and the like. The updatable attributes associated with a member profile are updated at regular intervals or after any transaction or non-transaction event triggered by the member or customer or system.

Upon triggering of an event (either transaction or non-transaction event) by a member, a segmentation rule is retrieved from a promotion or notification rule. The aforementioned segmentation rule comprises of a rule definition and rule criteria. Once the segmentation rule has been retrieved the values associated with various updatable attributes of a member profile are matched with certain predetermined values of one or more corresponding attributes of the segmentation rule according to a rule criteria of the segmentation rule for dynamically accessing the qualification of a member or customer. In case a member or customer qualifies according to the segmentation rule and other promotion criteria, a reward or notification may be provided. Upon triggering of an event by the system, a segmentation rule is retrieved from promotion or notification rule and those members who qualify the segmentation rule and other promotion criteria receive the reward or notification.

In an aspect, the rule definition of the segmentation rule may comprise of name of the segmentation rule, description of the segmentation rule, applicable duration of the segmentation rule and status of the segmentation rule. Further, the rule criteria may comprise of one or more attributes and one or more conditional operators and one or more values associated with said one or more attributes. The one or more conditional operators may be selected from a group comprising of equal to, not equal to, greater than, lesser than, greater than or equal to, lesser than or equal to, between, in and not in, and the like.

The method and system described in the following paragraphs provide an easy and effective means of forming a segmentation rule that may be implemented by selecting the relevant member attributes and providing a comparison criterion and associated values to be compared against.

The foregoing has broadly outlined the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. Moreover, the present invention may be applicable to a plurality of industrial applications and may not particularly be restricted to the applications described by the embodiments present in the specification. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF DRAWINGS

The foregoing summary, as well as the following detailed description of preferred embodiments, is better understood when read in conjunction with the appended drawings. For the purpose of illustrating the invention, there is shown in the present document example constructions of the invention; however, the invention is not limited to the specific methods and apparatus disclosed in the document and the drawing:

FIG. 1a and FIG. 1b describe creation and implementation of a segmentation rule according to an exemplary embodiment.

FIG. 2 illustrates the system (200) for implementing the dynamic segmentation and targeting of customers and members.

FIG. 3 illustrates an example of an entity relationship diagram depicting the association of segmentation rules to promotions.

### DETAILED DESCRIPTION OF THE INVENTION

Some embodiments of this invention, illustrating all its features, will now be discussed in detail.

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present invention, the preferred, systems and methods are now described.

The disclosed embodiments are merely exemplary of the invention, which may be embodied in various forms.

The present application according to one of the aspects provides means for targeting customers or members of a loyalty program by segmenting the customers or members of a loyalty program by utilizing the most recent details of said customers or members. In an embodiment the present invention facilitates creation of a segmentation rule with one or more rule criteria also referred to as criteria that may be further used in dynamically targeting of customers or members for a plurality of needs. The list of members to be targeted may be identified based on the members satisfying the rule criteria at any given point in time and thus being dynamic. Throughout the specification the words customers and members may be used interchangeably.

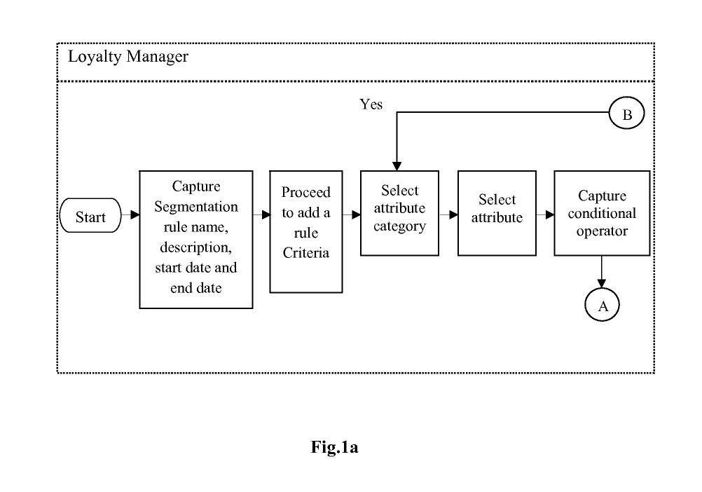

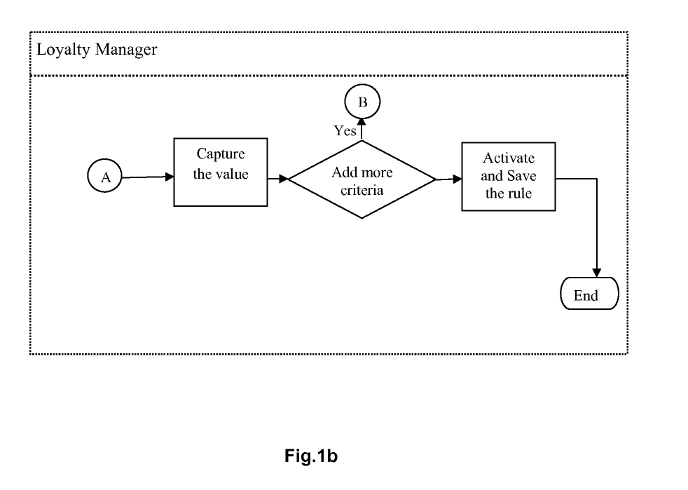

FIG. 1a and FIG. 1b describe creation and implementation of a segmentation rule according to an exemplary embodiment. The system and method described herein enables managing a wide variety of loyalty promotions offered to customers or members enrolled to a loyalty program. The loyalty program may be run and managed by a vendor, retailer etc for a plurality of reasons such as retaining customers, appreciating regular customers, targeting customers belonging to a particular segment, and the like. The system and method may enable managing a multitude of loyalty programs for offering rewards to customers, the loyalty programs may be targeted promotions, coupons, loyalty points, and the like. The method may enable take into consideration various customer interactions in a timely manner by managing heaps of digital footprints of customers or members of a particular loyalty program. It may also enable the retailers or vendors etc to manage and understand customer preferences, insights and customer touch points to address challenges of retaining and attracting customers. The present system and method may enable the retailers to understand and utilize information regarding changing landscape of customer behavior and thereby providing a personalized, integrated, seamless and rewarding experience across a plurality of channels.

The present system and method may provide personalized and targeted promotions and rewards to the customers by dynamically associating customers to a promotion based on predefined customer segmentation and promotion rules. Each customer or member may have a customer or member profile that may include a plurality of attributes related to the customer/member. A method for creation and implementation of the segmentation rule is described in FIG. 1a and FIG. 1b in accordance with an embodiment. The segmentation rule has two components the rule definition and rule criteria that enable the segmentation and structured targeting of the customers. The segmentation rule is configured by specifying the rule definition and then the rule criteria. The rule criteria are built using one or more attributes falling under an attribute category. Such attributes characterize a member and related behavior such as demographic, loyalty program attributes, purchase, non-purchase activities. Further, in the segmentation rule values are specified against which the attributes are compared using the conditional operators such as equal to, not equal to, greater than, lesser than, between, and the like.

In an embodiment, the present invention facilitates creation of a Dynamic Member Segmentation Rule that includes a rule criteria for identifying and segmenting the members that qualify the rule criteria. Further, the invention also facilitates Dynamic Targeting of members that enables associating the member segmentation rule to promotions, segments, campaign etc.

The method starts with capturing the segmentation rule name and description of the segmentation rule that may be together identified as the segmentation rule definition. In an aspect, such a segmentation rule definition may include the name of the segmentation rule, description of the segmentation rule, the duration for which the segmentation rule is applicable and the status of the segmentation rule. For example, the name of the segmentation rule may be ‘High valued female customers born in March’, the description of the segmentation rule may be ‘Female customers who are enrolled since 2010 and having birthday in March and have made purchases>=10,000 and made visits to the stores>=30 times’, the duration of the segmentation rule includes a start date and an end date for which the segmentation rule is to be effective, further, the status of the segmentation rule may be active.

Upon capturing the segmentation rule definition, the segmentation rule criteria may be defined. The segmentation rule criteria is a criterion that may include one or more attributes from an attribute category related to the customer or member, one or more conditional operators and corresponding predefined attribute values. A segmentation rule may have one or more related rule criteria that are to be qualified by a member for a promotion or notification to be executed.

The attributes included in the rule criteria may correspond to the updatable attributes in the member profile. The attributes may be selected from a attribute category that may include customer demographic, member loyalty, member transaction activities, member preferences, Member Loyalty Event, events related to member, and the like. The updatable attributes associated with a member profile are updated at regular intervals or after any transaction or non-transaction event triggered by the member or customer or system. For example, the attribute category customer demographic may include attributes such as Age, Educational background, Employment Type, First Name, Frequently Read Magazine, Frequently Read Newspaper, Gender, Household Income, Income, Last Name, Marital Status, Middle Name, Number of Children, Occupation, and the like. Further, the attribute category member loyalty may include attributes such as Enrolled Scheme, Membership Type, Tier, Tier Group, and the like. The attribute category member transaction activities may include attributes such as Last Accrual Date, Last Member Activity Date, Last Redemption Date, Number of Purchase Visits, Purchased Store, Reward Points Earned, Reward Points Redeemed, Highest Single Purchase Amount, Tier Credit Points Earned, Total Purchase Amount, and the like. Furthermore, the attribute category member preferences may include attributes such as Preferred Item Category, Preferred Mode of Communication (Operational Message), Preferred Mode of Communication (Personalized Message), Preferred Reward Category, and the like. Another attribute category Member Loyalty Event may include various attributes such as Enrolled Date, Enrolled Month, Enrolled Store, Enrolled Year, Number of Referrals, Number of Tier Movements, Recent Tier Movement Type, Referral Date, and the like. Lastly, the events related to member event attribute category may include attributes such as Anniversary Date, Anniversary Day, Anniversary Month, Anniversary Year, Birth Date, Birth Day, Birth Month, Birth Year, Spouse Birth Date etc.

Further, the conditional operators included in the rule criteria may be a selected from a group at least consisting of in, between, or, and, “<, >, <=, >=, =, !=”, and the like. The conditional operator connects the attributes to the predefined attribute values wherein the predefined attribute values correspond to an attribute. For example, the rule criteria may be set by selecting one or more attributes such as “Reward Points Balance”, “No of visits”, “Age” that may fall under the attribute categories such as transaction, demographics, loyalty attributes, and like. Conditional operators such as <, >, !=, =, and the like may be selected and defined/predefined values may be set corresponding to each selected attribute that may be compared using the conditional operator with the attribute values associated with the updatable attributes in the member profile. Once, the segmentation rule has been created the same may be activated by setting the status as active and an effective start date and an effective end date may also be provided by the manager.

It is essential to identify customers and members based on their characteristics and behavior and thereby segment them appropriately so that loyalty promotions, rewards, communications, etc. may be effectively personalized and delivered to targeted customers. In order to enable better means of targeting, the system enables segmenting the loyalty customers using the most recent details of the customer. An individual customer may belong to a particular segment at one point in time and may not qualify for the segment at a different point in time. Hence, maintaining multiple lists of segments and constantly making changes to such segments in order to keep them accurate all the time leads to wastage of resource. In order to overcome such a drawback the present system does not store any static segment lists and dynamically targets the customers qualifying the criteria of a segmentation at a particular time based on the latest customer details.

In an embodiment, the segmentation rule may be utilized for creating a static customer segment that may facilitate dynamically targeting the customers or members for a promotion, campaign, and the like. At the instance of the usage of the rule, the one or more rule criteria present in the segmentation rule are executed on the customer/member data stored in a database. The customers having attributes that satisfy the rule criteria are identified. For example, a promotion requiring segmenting all female customers above the age of 23 years and that belong to “gold” tier may be segmented by defining the segmentation rule with rule criteria as

Gender=Female AND

Age>=23 AND

Tier=Gold

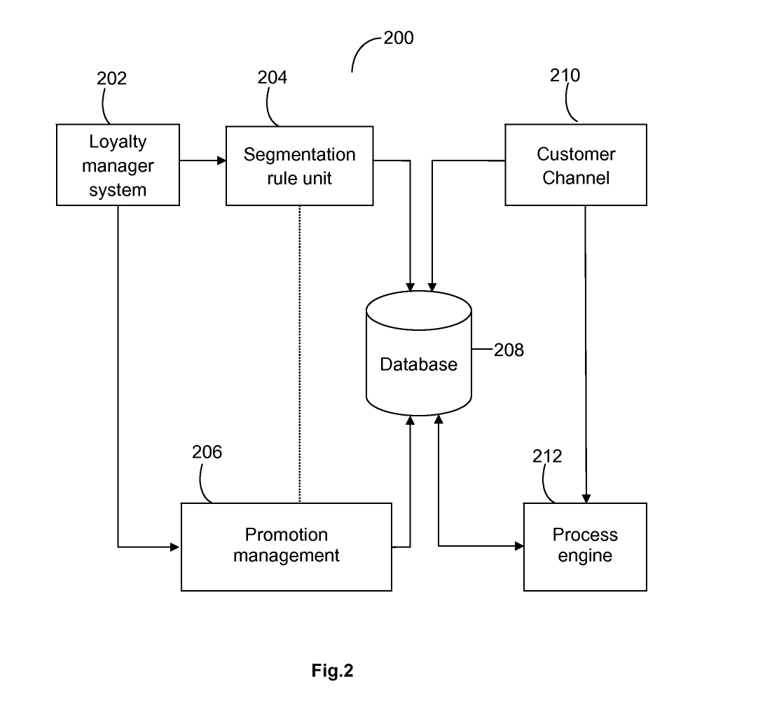

FIG. 2 illustrates the system (200) for implementing the dynamic segmentation and targeting of customers and members. The system (200) comprises of a loyalty manager system (202), a segmentation rule unit (204), a promotion management (206), a database (208), customer channel (210) such as a Point of Sale, Customer Portal, Mobile, Call Center, Kiosk and the like, and a process engine (212). The loyalty manager system (202) may enable a person managing the promotions to set up the segmentation rules according to the method described above. The segmentation rules are setup by the loyalty manager system (202) by utilizing the segmentation rule unit (204). The segmentation rule unit may also enable transmitting the segmentation rules to be stored in the database (208). The loyalty manger system (202) may also enable the person managing the promotions to set up promotion, campaign or notification rules and actions by utilizing the promotion management unit (206). A customer or member is enabled to perform various transactional or non-transaction activities by utilizing the customer channel (210). A customer channel (210) may also enable a customer to register for a loyalty program or promotional offer. The details provided by the customer are stored in the database (208). Details regarding any transaction or non-transactional activity performed by a customer are sent from the customer channel (210) to the process engine (212). The process engine (212) upon receiving the details extracts the member profile containing the updatable attributes from the database (208). The process engine also identifies the nature of the event that occurred by receiving the transaction or non-transaction details. The process engine (212) retrieves the offers and the segmentation rule and compares the attributes in the segmentation rule with the attributes and related attribute values present in the customer/member profile. The process engine determines whether the customer/member qualifies for a promotion by applying the segmentation rule criteria and other promotion criteria. In case the customer/member qualifies a segmentation rule and other promotion criteria, the process engine applies the related promotion. For example, upon qualification the process engine may add reward points to the member or may provide an instant discount or may send a personalized notification to the customer/member.

A segmentation rule can be associated to a promotion or campaign for targeting the promotion to a segment of customers that satisfy the defined segmentation rule. At the time when the promotion has to be executed, the system dynamically retrieves the list of customers satisfying the segmentation rule and associates the promotion to these customers. When a segmentation rule is associated to a promotion or campaign, the system dynamically creates customer segments at the time of promotion execution. Therefore, the system does not save any segment lists and hence segments are created dynamically using the defined segmentation rules.

For example, the retailer may decide to promote repeat purchases through a newly launched online store. Such an online store may be promoted by awarding 5 reward points for every dollar spent in the online store if the customer has earlier made a purchase in the online store. A promotion called “Online Store Repeat Purchase Offer” may be defined. The system may facilitate defining a segmentation rule called “Online store customers” with the rule criteria “Last Purchased Store=‘Online Store’ and the promotion may give 5 reward points for every dollar spent. The promotion “Online Store Repeat Purchase Offer” associated with the segmentation rule “Online store customers” may be executed on Day ‘n’. In such a case, on Day ‘n’ at 9:00 AM there may not be any customers eligible as “Online store customers”. At 10:00 AM Customers A, B and C may make a purchase in the online store and thereby the attribute associated with them is updated. Hence, at 10:01 AM customers eligible to be in the “Online Store Customers” segment are Customer A, B and C. Such a dynamic segmentation is based on the latest updated customer attributes. On Day ‘n+1’ at 9:00 AM customers A, B, C and X make a purchase in the online store, since the attribute related to customer A, B and C qualify they are eligible to be in the “Online Store Customers” segment and hence avail the “Online Store Repeat Purchase Offer” and receive the 5 reward points on every dollar spent. Upon the transaction the attribute related to customer X is updated and thereon customer X also becomes eligible for the “Online Store Repeat Purchase Offer” promotion.

The system described above is an exemplary embodiment a person skilled in the art may be able to implement the underlying inventive concept in one or more ways. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

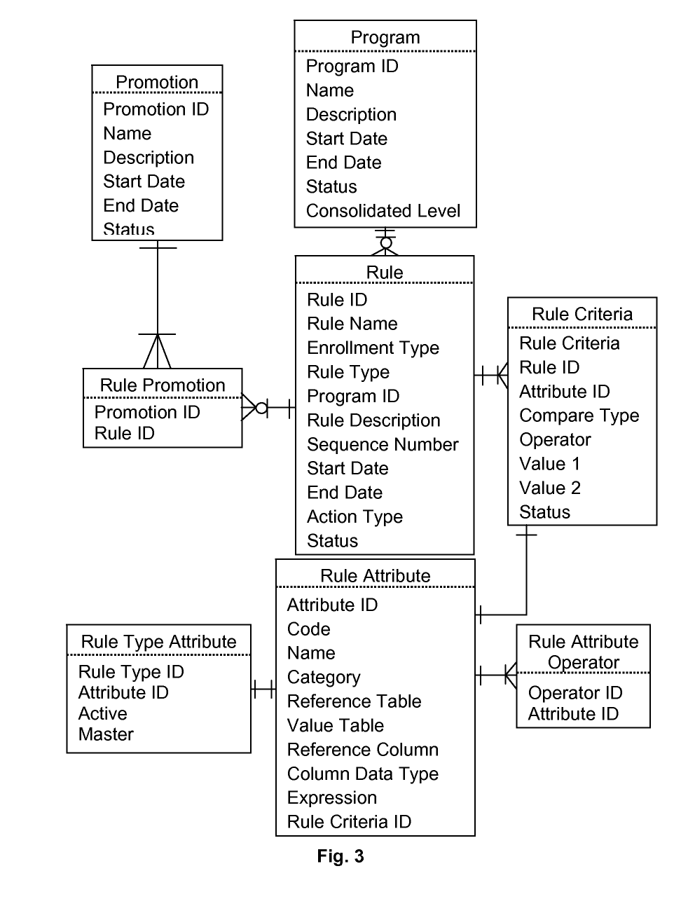

FIG. 3 illustrates an example of an entity relationship diagram depicting the association of segmentation rules to promotions. The Program entity captures the program details, promotion entity captures the Promotion definition, the rule entity captures the Rule definition and Rule Criteria, the Rule Promotion entity associates rules with a particular promotion, the Rule Attribute entity captures Attributes for each rule, the Rule Type Attribute entity captures Attributes applicable to each rule type, and the Rule Attribute Operator entity captures Operator applicable for each attribute.

At the time of execution of the promotion, the customers who are eligible for the promotion are dynamically determined. At each instance, the segment to which a customer belongs to might change. The flexibility of creating a dynamic segmentation rule and associating it to a promotion overcomes the basic problem of creating multiple customer segment lists in the system and updating them at frequent intervals.

The methodology and techniques described with respect to the exemplary embodiments can be performed using a machine or other computing device within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in a server-client user network environment, or as a peer machine in a peer-to-peer (or distributed) network environment.

Moreover, although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

The preceding description has been presented with reference to various embodiments. Persons skilled in the art and technology to which this application pertains will appreciate that alterations and changes in the described structures and methods of operation can be practiced without meaningfully departing from the principle, spirit and scope.

We claim:

1. A method for dynamic segmentation of members and further rewarding or transmitting one or more promotional notifications to members having an associated member profile, wherein the member profile includes one or more updatable attributes, the method comprising the steps of
a. retrieving a segmentation rule from a promotion rule stored in a database based on triggering of a promotion or notification;
b. dynamically assessing the qualification of members based on matching corresponding predetermined value of one or more attributes of the segmentation rule with the value of the updatable attribute of the member profile based on a rule criteria of the segmentation rule;
c. rewarding based on rule action of a promotion or transmitting the promotional notification to the qualified member based on the rule action of the segmentation rule.

2. The method as claimed in claim 1, wherein the segmentation rule comprises of said rule criteria, and a rule definition.

3. The method as claimed in claim 2, wherein the rule definition comprises of name of the segmentation rule, description of the segmentation rule, applicable duration of the segmentation rule and status of the segmentation rule.

4. The method as claimed in claim 1, wherein the rule criteria comprises of one or more attributes and one or more conditional operators and one or more values associated with said one or more attributes.

5. The method as claimed in claim 4, wherein the one or more attributes are selected from attribute categories comprising of customer demographic, member loyalty attributes, member transaction activities, member preferences, events related to member and events related to customer.

6. The method as claimed in claim 4, wherein the one or more conditional operators are selected from a group comprising of equal to, not equal to, greater than, lesser than, greater than or equal to, lesser than or equal to, between, in and not in.

7. The method as claimed in claim 1, wherein the triggering of the event is triggering of a transaction (like purchase) or non-transaction (like refer a friend, profile update, tier upgrade) by the member or the system.

8. The method as claimed in claim 1, wherein some of the member profile attributes are updated upon triggering of events recognized by the product.

9. A system for dynamic segmentation of members and further rewarding or transmitting one or more promotional notifications to members comprising a loyalty manager system, a segmentation rule unit, a promotion management unit, a database, customer channel, and a process engine wherein
the loyalty manager system is adapted to facilitate creating and managing one or more segmentation rules by utilizing the segmentation rule unit, and is adapted to facilitate creating and managing one or more promotion rules by utilizing the promotion management unit;
the segmentation rule unit is adapted to send the created segmentation rules to the database;
the customer channel is adapted to facilitate performing various transactional or non-transaction activities and send related details to the process engine, and also enables a customer to register for a loyalty program or promotional offer;
the database is adapted to receive and store one or more segmentation rules, promotion rules, and details related to transactional or non-transaction activities and the details related to the customer;
the process engine is adapted to retrieve a promotion or notification rule and its associated segmentation rule stored in a database based on triggering of a transaction or non-transaction event in the customer channel (210), dynamically assess the qualification of members based on matching corresponding predetermined value of one or more attributes of the segmentation rule with the value of the updatable attribute of the member profile based on a rule criteria of the segmentation rule; and is adapted to reward or notify based on a promotion or notification.
